(19) United States
(12) Patent Application Publication
(10) Pub. No.: US 2018/0126762 A1
(43) Pub. Date: May 10, 2018

(54) QUESTIONNAIRE STAMP

(71) Applicant: Institute of Neuropsychiatry, Tokyo (JP)

(72) Inventors: Satoru TSUIKI, Tokyo (JP); Yuichi INOUE, Tokyo (JP); Yukiko NARAHARA-ENO, Tokyo (JP)

(21) Appl. No.: 15/611,758

(22) Filed: Jun. 1, 2017

(30) Foreign Application Priority Data
Nov. 10, 2016 (JP) 2016-005424U

(51) Int. Cl. B41K 1/38

(52) U.S. Cl. CPC B41K 1/38

(57) ABSTRACT

A questionnaire stamp is disclosed which has: a question item indicating section that indicates at least one question item concerning a predetermined symptom that a patient may have; a check result entry section in which a check result as to whether the question item is applicable to the patient can be recorded; and an applicable item counting section in which the total number of applicable question items is entered, wherein the questionnaire stamp is affixed to a given location of the patient's medical record or an auxiliary record form of the medical record.

### CROSS-REFERENCES TO RELATED APPLICATIONS

This application relates to and claims priority from Japanese Utility Model Application No. JP2016-005424U, filed on Nov. 10, 2016, the entire disclosure of which is incorporated herein by reference.

### BACKGROUND

### Field

The present disclosure generally relates to a questionnaire stamp that serves as a device which assists in recording subjective and objective changes of symptoms of obstructive sleep apnea syndrome (OSAS) patients, which is to be used for the purpose of determining the timing of conducting a follow-up sleep testing to objectively assess treatment effectiveness in such OSAS patients.

### Description of Related Art

Obstructive sleep apnea syndrome (OSAS) is a disease that involves pauses in breathing or shallow breathing periods during sleep due to obstruction in the upper airway, and it affects a high percentage (about 2 to 4%) of adults. OSAS produces excessive daytime sleepiness, which can increase the risk of driving and work-related accidents. OSAS may also be responsible for the development of metabolic syndrome, cardiovascular and cerebrovascular diseases, and other complications. The importance of properly controlling the clinical state of OSAS with a good treatment outcome is therefore recognized.

Examples of conservative therapy for OSAS include nasal continuous positive airway pressure (nCPAP) therapy, which is the first-line treatment for OSAS used worldwide, and therapy using oral appliances, which is known as a second-line treatment. In nCPAP, a nasal mask is used so as to apply positive pressure through the mask to maintain positive air pressure within the upper airway and thereby keep the upper airway open continuously. Meanwhile, a typical example of the above-indicated oral appliances is a device called a mandibular advancement device (MAD) that shifts the lower jaw forward to enlarge the upper airway and maintains the upper airway in that state (see, for example, Takaesu Y, et al., J Clin Sleep Med 2016; 12: 1113-1119). Both nCPAP and an MAD can improve OSAS and maintain an improved state. However, nCPAP, although it can achieve a high rate of improvement of OSAS, may cause nasal symptoms due to positive pressure, and the wearing of a mask may provide an uncomfortable feeling for the patient. These factors lead to low compliance (i.e. the willingness to use the device as prescribed) and more than a few patients discontinue nCPAP therapy. On the other hand, an MAD is simple, inexpensive, and easy to use, and may be applied to patients who have abandoned nCPAP, but an MAD is known to be not as efficacious as nCPAP. It is therefore desirable to confirm that a treatment effect is actually obtained by an MAD and to then continue the follow-up operation for a long time (see, for example, Fukuda T, et al., Sleep Med 2014; 15: 367-370). Moreover, since an MAD cannot provide a complete cure for OSAS, patients need to use the device for a long time. If, however, an MAD is used for a long time while leaving an inadequate effect of treatment by the MAD as it is, this can also increase the risk of developing complications arising from OSAS. The effects of treatment by an oral appliance are assessed in the same way as in making a definite diagnosis of OSAS; namely, by performing overnight polysomnography in a state where the patient wears an MAD which has already been adjusted so as to be able to properly shift the lower jaw forward, and counting the number of apnea and hypopnea events occurring per hour (Apnea Hypopnea Index; AHI). When the value of AHI is less than five per hour, it is determined that OSAS is favorably controlled. This is the standard, conventionally-known method for assessing the treatment effect of an MAD.

When the use of an MAD alleviates the chief complaint and chief symptoms of OSAS, i.e., snoring or pauses in breathing noticed by the bed partner and the patient's chronic tiredness and daytime sleepiness, the patient and his/her dentist sometimes evaluate that a certain positive effect has been obtained by the use of the MAD. In such a situation, performing overnight polysomnography with the MAD fitted on the patient may be skipped, and this is considered to be a medical problem. In fact, there are many cases in which the use of an MAD does not actually improve AHI although it shows sufficient improvement in snoring symptoms, and such cases are considered to be problems (see, for example, Arisa Ebato, Satoru Tsuiki, Fernanda Almeida, Yuuya Kohzuka, Hiroshi Suzuki, Yuichi Inoue, Cessation of snoring with an increased apnea hypopnea index during mandibular advancement device therapy: A case report, Final program, American Academy of Dental Sleep Medicine 26th Annual Meeting, Boston, Mass., Jun. 2-4, 2017).

As already stated above, it has been reported that prolonged use of an MAD, while leaving an inadequate effect of treatment by the MAD as it is, may also increase the risk of developing complications; however, as an underlying factor, patients want to reduce the costs taken to perform overnight polysomnography with the MAD fitted on the patient. Further, there are only a limited number of medical institutions that can provide such overnight polysomnography, so that patients have to wait for a long time before receiving the same, which is also considered to be a problem. Moreover, if an overnight polysomnogram taken with the MAD fitted on the patient shows that AHI has not been sufficiently improved, further adjustment of the MAD is necessary and then a further overnight polysomnogram needs to be taken. Significant treatment costs will be necessary if a patient takes an overnight polysomnogram several times as described above.

As an alternative for AHI, which is an index obtained by overnight polysomnography, a respiratory disturbance index (RDI), which can be obtained by using a portable sleep monitor, has also been used recently as an index to assess the treatment effects of an MAD. Such simple respiration monitor has the advantage of enabling testing at home and the cost for the testing is inexpensive as compared to overnight polysomnography.

### SUMMARY

A portable sleep monitor, however, has drawbacks of being complicated for elderly or child patients to use, and such complicated use may lead to a great economic or psychological burden for patients and can create problems with regard to the accuracy of measurement. Moreover, unlike overnight polysomnography, a portable sleep monitor is unable to precisely record a sleeping condition, and an RDI value may deviate from an AHI value obtained by overnight polysomnography. In addition, such portable sleep monitor is a testing device not usually used at dentists, and installing the monitor will involve a large cost burden for dentists. Furthermore, an examination using such monitor does not fall within the range of dental care services provided by health insurance, so the patient will have to cover the cost of the examination by themselves, which will increase the costs to be borne by the patient, although such cost burden will still not be as high as in overnight polysomnography. Therefore, such examination using a simple respiration monitor cannot be regarded as a common way of examination. Accordingly, a simple and cost-saving method has been demanded which can provide information for finding that an MAD is properly adjusted and that the patient's compliance with the device is favorably maintained and which can also provide information for determining an appropriate timing of taking an overnight polysomnograph to evaluate the effect of the MAD treatment.

Under these circumstances, an object of the present disclosure is to provide a questionnaire stamp that serves as a simple and cost-saving method for facilitating the discovery of obstructive sleep apnea syndrome (OSAS) and further facilitating the evaluation of the effect of treatment of obstructive sleep apnea syndrome (OSAS) by an MAD.

In order to achieve the above object, a questionnaire stamp according to an aspect of the present disclosure comprises: a question item indicating section that indicates at least one question item concerning a predetermined symptom that a patient may have; a check result entry section in which a check result as to whether the question item is applicable to the patient can be recorded; and an applicable item counting section in which the total number of applicable question items is entered, wherein the questionnaire stamp is affixed to a given location of the patient's medical record or an auxiliary record form of the medical record.

With the use of the above questionnaire stamp, the patient is questioned according to each item indicated in the question item indicating section, a check mark is placed in the check result entry section if the question item applies to the patient, and the total number of applicable question items is finally written in the applicable item counting section, whereby the medical record with the above stamp affixed thereto serves as a simple questionnaire sheet that helps the discovery of possible obstructive sleep apnea syndrome (OSAS) in the patient.

Furthermore, by using the above questionnaire stamp to record, as a score, interview results that change with time, a decrease of the score can be easily noticed, so that the score works as an effective and simplified index for presuming an improvement of OSAS and determining the timing of evaluating the effect of MAD treatment through overnight polysomnography.

Such a questionnaire stamp is a simple and inexpensive method for facilitating the discovery of obstructive sleep apnea syndrome (OSAS) and further facilitating the evaluation of the effect of treatment of obstructive sleep apnea syndrome (OSAS) by an MAD.

The question item indicating section may indicate the question item in a simplified manner by using a character contained in a word that represents the question item.

The question item indicating section may indicate four question items in a simplified manner such that each question item is indicated by a character that represents the question item.

The question item indicating section may indicate four letters of S, T, 0 and P, in this order.

The check result entry section may be provided adjacent to each item in the question item indicating section.

Another aspect of the present disclosure is a medical record having a questionnaire stamp affixed thereto.

Still another aspect of the present disclosure is a stamper having a rubber stamp formed as a questionnaire stamp.

Still another aspect of the present disclosure is a questionnaire stamp which is electronically provided at a given location of an electronic medical record of a patient or an auxiliary electronic record form of the electronic medical record.

### BRIEF DESCRIPTION OF DRAWINGS

FIG. 1 is a perspective illustration showing an example of a stamper for affixing a questionnaire stamp.

FIG. 2 illustrates an example of a questionnaire stamp.

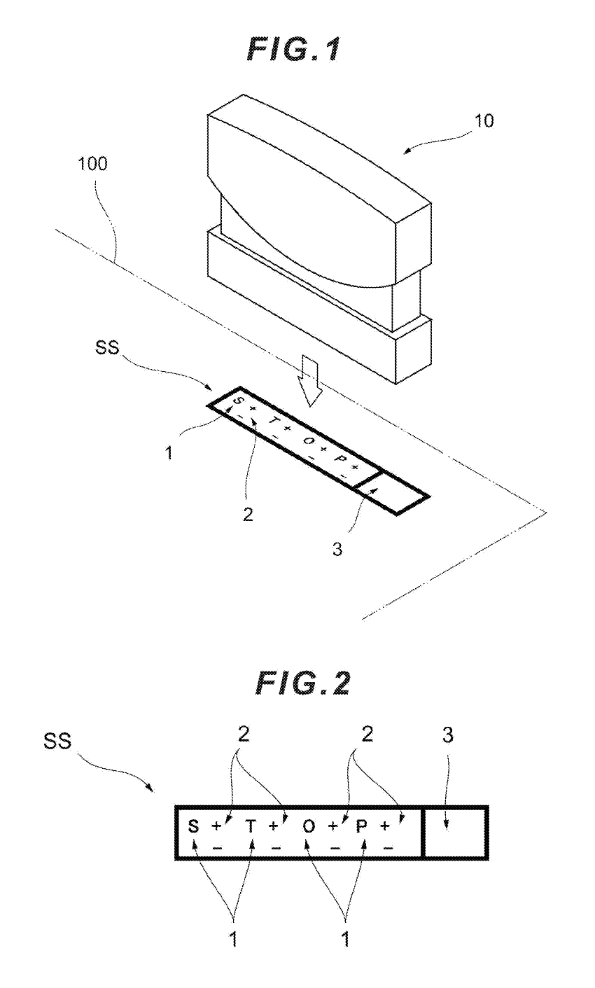

### DETAILED DESCRIPTION

Hereinafter, preferred embodiments of the present disclosure will be described with reference to the attached drawings. In the drawings, elements given the same reference sign have the same or similar configurations.

A questionnaire stamp according to the present embodiment is a mark which is stamped at a given location of a medical record 100 with a stamper 10 so as to help a medical interview. Such questionnaire stamp may serve as a device assisting in recording subjective and objective changes in the symptoms of obstructive sleep apnea syndrome (OSAS). The questionnaire stamp may be designed, for example, to have a question item indicating section 1, a check result entry section 2, and an applicable item counting section 3.

The stamper 10 includes, for example, a porous rubber stamping part which is impregnated with ink so as to make it possible to repeatedly put a stamp without applying ink to the stamping part each time of stamping. A known stamping device can be used for the stamper 10. A questionnaire stamp is formed on the rubber stamping part.

By way of example, the questionnaire stamp (hereinafter, also referred to as a “STOP stamp”) is a stamp having a width of 70 mm and a length of 15 mm and affixed at a given location of the medical record 100 with the stamper 10. The width and the length of the stamp can be changed as necessary. Such STOP stamp SS can be used, for example, by doctors (e.g., dentists) in the following manner: using a STOP stamp SS affixed on the patient's medical record 100 with the stamper 10, questioning the patient concerning each item indicated in the question item indicating section 1; checking the “+” mark in the check result entry section 2 if the patient responds in the positive regarding the item, and checking the “−” mark if the patient responds in the negative; and then entering the total number of the checked “+” marks in the applicable item counting section 3 so as to provide the score of the patient.

The question items in the present embodiment are as follows, although such items are not specifically limited. That is, in order for the STOP stamp SS to serve as a simple questionnaire for discovering possible obstructive sleep apnea syndrome (OSAS) in the patient, the question item indicating section 1 indicates four items—snoring (S), tiredness (T), observed apnea (O), and high blood pressure (P), simply by four letters S, T, O and P that represent the respective four items (see, for example, Chung F, Yegneswaran B, Liao P, Chung S A, Vairavanathan S, Islam S, Khajehdehi A, Shapiro CM, STOP questionnaire: a tool to screen patients for obstructive sleep apnea, Anesthesiology 2008 May; 108(5):812-21). Letters other than the above may also be used as desired. The important thing is to adopt a simplified, space-saving indication using a representative letter, such as an initial letter, for each item. Provided adjacent to each item in the question item indicating section 1 is the check result entry section 2 comprised of the “+” and “−” marks. Further, the applicable item counting section 3 in which the total number of the checked “+” marks is entered as a “STOP score” is provided on the right end of the STOP stamp SS.

As a result of questioning the patient using the STOP stamp SS, if, for example, the patient has positive results under two items, in other words, the STOP score of the patient is two or more, the development of OSAS can be suspected. If an MAD is properly adjusted for the patient, the patient's STOP score is expected to decrease as compared to the start of the treatment. Furthermore, if the patient's compliance with the device is favorably maintained and if the patient's STOP score shows no change, the patient's MAD can be considered to have been sufficiently adjusted, and this works as the grounds for deciding to take an overnight polysomnograph to assess the effect of treatment by the MAD. In other words, the above STOP stamp SS, which has been invented as a stamp that can assist in recording the STOP score in the treatment of OSAS, and the use of such stamp SS to record the varying STOP scores, are effective for evaluating an improvement of OSAS and determining the timing of assessing the effect of MAD treatment through overnight polysomnography.

Such STOP stamp SS is affixed to the medical record 100 by the dental staff, or by the dentist him/herself, before starting the care each time, and accordingly, it is possible to help the dentist to remember to ask the prescribed questions to the patient when the dentist sees the medical record 100. Moreover, even if the dentist forgets to ask such questions, the STOP stamp SS affixed to the medical record 100 is easy to notice, which enables dental staffs to find that the dentist has not filled in the question items. In addition, such STOP stamp method is easy, requires no complicated medical or dental knowledge, enables changes of the STOP score with time to be readily observed on the medical record 100, and facilitates the sharing of such information by the dentist staff. In addition, the use of the STOP stamp SS also allows the patient to visually understand the change of his/her STOP score with time, and accordingly, such use can be expected to be effective in further motivating the patient to use an MAD.

Owing to the configuration described above, the STOP score decreased (3±1→1±1, p<0.01) in a STOP group (a group using the STOP stamps SS) before and after the use of an MAD, and the AHI value decreased in both the STOP group (17±10/hr→4±4/hr, p<0.01) and the control group (21±12/hr→8±8/hr, p<0.01). The median [25-75%] period taken from the start of MAD treatment until the overnight polysomnography was performed with the MAD fitted on the patient was longer in the STOP group (147 [115-215] days) than in the control group (a group without using the STOP stamp SS) (113 [70-198] days) (p<0.01), but the successful rate of treatment was higher in the STOP group (64%) than in the control group (41%) (p<0.01).

As described above, using the STOP stamp SS to record a STOP score that changes with time and find a decrease of the score can be said to be a simple and effective index for presuming improvement of OSAS and determining the timing of conducting overnight polysomnography to assess the effect of MAD treatment. Information provided by such use of the STOP stamp SS can be considered useful for both patients and dentists. Furthermore, the method using the STOP stamp SS is easy and inexpensive, and can also be used for OSAS treatment other than treatment with an MAD (e.g., nCPAP treatment practiced by a physician).

The above-described embodiments are preferred embodiments of the present disclosure; however, the present disclosure is not limited to the described embodiments and can be modified in various ways without departing from the gist of the present disclosure. For example, the STOP stamp SS described in the above embodiments is just an example, and the shape, design, characters, size, color of ink, and the like are not limited to those described above. Furthermore, each of the question item indicating section 1, the check result entry section 2, and the applicable item counting section 3 of the STOP stamp SS is not limited to the above, and the shape, design, characters, size, color and layout thereof are not limited to those described above.

Furthermore, although the above-described embodiments describe the case in which the STOP stamp SS is used by dentists or dental staffs, physicians can obviously use a questionnaire stamp, like the STOP stamp SS, to question the patient.

Furthermore, although the above-described embodiments describe the case where the STOP stamp (questionnaire stamp) is applied to the medical record 100, this is just a preferred example and the STOP stamp (questionnaire stamp) can obviously be applied to other kinds of forms used in the care of the patient, such as an auxiliary record form of the medical record.

Moreover, in a recent electronic health record system in which doctor's findings, etc., are input to each electronic health record on a computer, a template of “S+−T+−O+−P+−,” like the above-described STOP stamp SS, may be electronically added to an electronic health record, so as to delete either the “+” or the “−” mark, which is not applicable to the patient, and to count the total number of remaining “+” marks to thereby obtain a STOP score in the same way as in the process of using the stamper 10. Alternatively, a “S T O P” template may be used so as to input a “+” mark for any applicable items and count the total number of “+” marks input to thereby obtain a STOP score. Examples of the electronic health record include a patient's electronic medical record and an auxiliary electronic record form for such electronic medical record.

The present disclosure is suited for use in assisting the recording of subjective and objective changes of symptoms of obstructive sleep apnea syndrome (OSAS).

According to the present disclosure, a simple and cost-saving method can be provided that facilitates the discovery of obstructive sleep apnea syndrome (OSAS) and further facilitates the evaluation of the effect of treatment of obstructive sleep apnea syndrome (OSAS) by an MAD.

What is claimed is:

1. A questionnaire stamp comprising:
a question item indicating section that indicates at least one question item concerning a predetermined symptom that a patient may have;
a check result entry section in which a check result as to whether the question item is applicable to the patient can be recorded; and
an applicable item counting section in which a total number of applicable question items is entered,
wherein the questionnaire stamp is affixed to a given location of a medical record of the patient or an auxiliary record form of the medical record.

2. The questionnaire stamp according to claim 1, wherein the question item indicating section indicates the question item in a simplified manner by using a character contained in a word that represents the question item.

3. The questionnaire stamp according to claim 2, wherein the question item indicating section indicates four question items in a simplified manner such that each question item is indicated by a character that represents the question item.

4. The questionnaire stamp according to claim 3, wherein the question item indicating section indicates four letters of S, T, O and P, in this order.

5. The questionnaire stamp according to claim 4, wherein the check result entry section is provided adjacent to each item in the question item indicating section.

6. A medical record to which a questionnaire stamp according to claim 1 is affixed.

7. A stamper having a rubber stamp formed as a questionnaire stamp according to claim 1.

8. The questionnaire stamp according to claim 1 which is electronically provided at a given location of an electronic medical record of the patient or an auxiliary electronic record form of the electronic medical record.
